(19) United States
(12) Patent Application Publication
(10) Pub. No.: US 2024/0133460 A1
(43) Pub. Date: Apr. 25, 2024

(54) COOLING MECHANISM OF VEHICLE POWER TRANSMISSION DEVICE

(71) Applicant: TOYOTA JIDOSHA KABUSHIKI KAISHA, Toyota-shi (JP)

(72) Inventors: Kotaro ARATA, Toyota-shi (JP); Shinichiro SUENAGA, Nagoya-shi (JP); Iori MATSUDA, Toyota-shi (JP); Kenta TABUCHI, Toyota-shi (JP)

(73) Assignee: TOYOTA JIDOSHA KABUSHIKI KAISHA, Toyota-shi (JP)

(21) Appl. No.: 18/366,855

(22) Filed: Aug. 7, 2023

(30) Foreign Application Priority Data
Oct. 19, 2022 (JP) 2022-168677

(51) Int. Cl. F16H 57/04

(52) U.S. Cl. CPC F16H 57/0413; F16H 57/0436

(57) ABSTRACT

Since the oil pump and the oil cooler are provided in the rear cover and the cooling oil passages for guiding the oil to the respective electric motors MG are integrated in the rear cover, the cooling oil passages do not pass through other case members other than the rear cover. As a consequence, it is possible to shorten the cooling oil passage through which the oil is guided to the respective electric motors MG.

### CROSS-REFERENCE TO RELATED APPLICATION

This application claims priority to Japanese Patent Application No. 2022-168677 filed on Oct. 20, 2022, incorporated herein by reference in its entirety.

### BACKGROUND

### 1. Technical Field

The present disclosure relates to a cooling mechanism of a vehicle power transmission device that uses at least an electric motor as a power source.

### 2. Description of Related Art

Japanese Unexamined Patent Application Publication No. 2017-67258 (JP 2017-67258 A) discloses a cooling mechanism of a power transmission device including an oil pump that discharges oil sucked up from an oil pan, an oil cooler that cools oil, a first oil passage that guides the oil discharged from the oil pump to the oil cooler, and a second oil passage that guides the oil cooled by the oil cooler to a heat generation source.

### SUMMARY

In the cooling mechanism of the power transmission device according to JP 2017-67258 A, a transaxle case is constituted by three case members of a housing, a casing, and a rear cover, and the housing and the rear cover are separated from each other with the casing interposed therebetween. Further, an oil pump is provided in the rear cover, an oil cooler is provided in the housing, and a cooling oil passage (first oil passage) connecting the oil pump and the oil cooler is provided via the casing. As a result, there is a problem that the cooling oil passage constituting the cooling mechanism becomes longer.

The present disclosure has been made in view of the above circumstances, and an object of the present disclosure is to provide a cooling mechanism of a vehicle power transmission device capable of shortening a length of the cooling oil passage when cooling an electric motor.

The gist of the present disclosure is (a) a cooling mechanism of a vehicle power transmission device that uses at least an electric motor as a power source, and the cooling mechanism is characterized in that:
(b) a case for accommodating the electric motor includes at least a rear cover that is adjacent to the electric motor in a direction of a rotation axis of the electric motor and that is disposed perpendicularly to the rotation axis of the electric motor;
(c) an oil pump and an oil cooler are provided on the rear cover; and
(d) a cooling oil passage for guiding oil to the electric motor is integrated in the rear cover.

According to the present disclosure, since the oil pump and the oil cooler are provided in the rear cover, and the cooling oil passage for guiding the oil to the electric motor is integrated in the rear cover, the cooling oil passage does not pass through another case member other than the rear cover. As a result, it is possible to shorten the cooling oil passage for guiding the oil to the electric motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a skeleton diagram for explaining an overall configuration of a vehicle power transmission device to which the disclosure is applied;

FIG. 2 is a view of the rear cover of FIG. 1 from the inside side of the power transmission device;

FIG. 3 is a view of the rear cover of FIG. 1 from an external side of the power transmission device;

FIG. 4 is a diagram illustrating a structure of a cooling oil passage formed in a rear cover.

### DETAILED DESCRIPTION OF EMBODIMENTS

Hereinafter, examples of the present disclosure will be described in detail with reference to the drawings. Note that, in the following embodiments, the drawings are appropriately simplified or modified, and the dimensional ratios, shapes, and the like of the respective portions are not necessarily drawn accurately.

### Examples

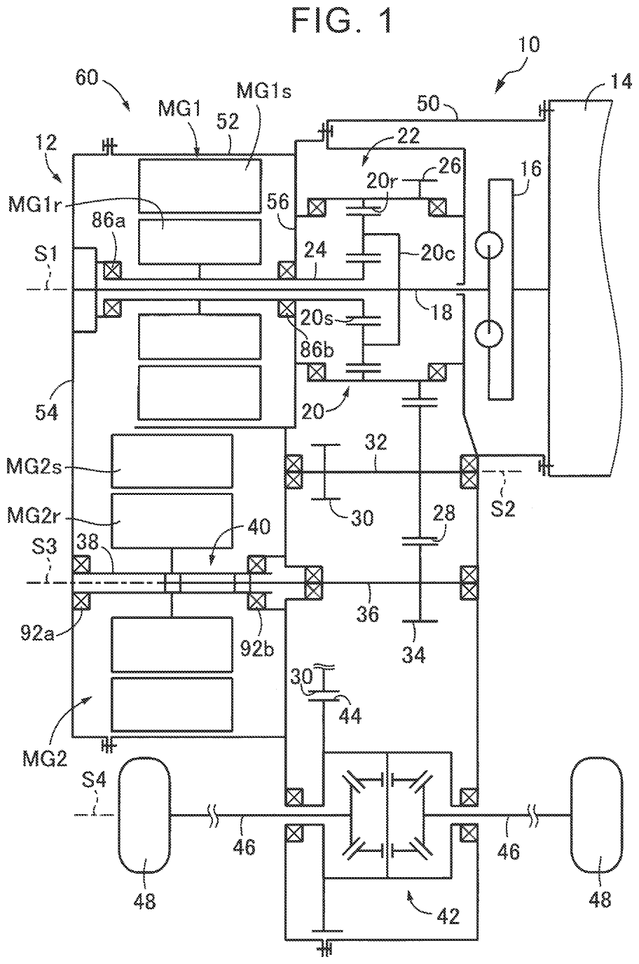

FIG. 1 is a skeleton diagram for explaining an overall configuration of a vehicle power transmission device 10 (hereinafter, referred to as a power transmission device 10) to which the present disclosure is applied. The power transmission device 10 is a transaxle of a horizontal hybrid type such as an FF vehicle. The power transmission device 10 includes, in the case 12, a fourth axis S4 (hereinafter, referred to as the respective axes S when these axes are not distinguished) from the first axis S1 which is parallel to the vehicle-width direction. An input shaft 18 connected to the engine 14 via a damper device 16 is disposed on the first axis S1, and a single pinion type planetary gear unit 20 and a first electric motor MG1 concentric with the first axis S1 are disposed. The planetary gear unit 20 and the first electric motor MG1 function as the electric differential unit 22, and the input shaft 18 is connected to the carrier 20c of the planetary gear unit 20, the rotor shaft 24 of the first electric motor MG1 is connected to the sun gear 20s, and the output gear 26 is provided on the ring gear 20r.

The first electric motor MG1 is a so-called motor generator, and the rotational speed of the engine 14 is continuously changed by controlling the rotational speed of the sun gear 20s by, for example, regeneration control functioning as a generator. The first electric motor MG1 includes a stator MG1s that is a stator and a rotor MG1r that is a rotor. The rotational axis of the first electric motor MG1 corresponds to the first axis S1. The engine 14 is an internal combustion engine such as a gasoline engine or a diesel engine, and is used as a power source for traveling.

On the second axis S2, a counter shaft 32 provided with a reduction large gear 28 and a reduction small gear 30 is rotatably disposed. The reduction large gear 28 is meshed with the output gear 26. Furthermore, the reduction large gear 28 is meshed with a motor-output gear 34 arranged on the third axis S3. The motor output gear 34 is provided on the gear shaft 36. The gear shaft 36 is connected to the rotor shaft 38 of the second electric motor MG2 disposed on the third axis S3 via the spline-fitting portion 40 so as to be capable of transmitting power. The second electric motor MG2 is a so-called motor generator, and is used as a power source for traveling, for example, by being subjected to power running control so as to function as an electric motor. The second electric motor MG2 includes a stator MG2s that is a stator and a rotor MG2r that is a rotor. The rotational axis of the second electric motor MG2 corresponds to the third axis S3.

The reduction small gear 30 is meshed with a differential ring gear 44 of a differential device 42 disposed on the fourth axis S4. Power from the engine 14 and the second electric motor MG2 is transmitted to the left and right drive wheels 48 through the differential device 42 and the left and right drive shafts 46.

The case 12 includes three case members: a housing 50, a casing 52, and a rear cover 54. The housing 50 forms a space for accommodating the damper device 16, the planetary gear unit 20, the reduction large gear 28, the reduction small gear 30, the differential device 42, and the like. The casing 52 is inserted between the housing 50 and the rear cover 54 and is formed in a cylindrical shape. In the casing 52, a partition wall 56 is formed to define a space for accommodating the first electric motor MG1 and the second electric motor MG2 (hereinafter, referred to as electric motor MG when they are not distinguished from each other) and a space for accommodating the planetary gear unit 20, the differential device 42, and the like. The first electric motor MG1 and the second electric motor MG2 correspond to the electric motor of the present disclosure, and the housing 50, the casing 52, and the rear cover 54 correspond to the case member of the present disclosure.

The rear cover 54 is connected to the casing 52 so as to close an opening formed at one end in the direction of each axis S in the casing 52 formed in a cylindrical shape. Thus, the casing 52 and the rear cover 54 form a space for accommodating the electric motor MG. The rear cover 54 is disposed at a position adjacent to each electric motor MG in the direction of each axis S, that is, in the direction of the rotational axis of each electric motor MG. The rear cover 54 is disposed perpendicularly to each axis S. That is, the rear cover 54 is disposed perpendicularly to the rotational axes of the electric motors MG.

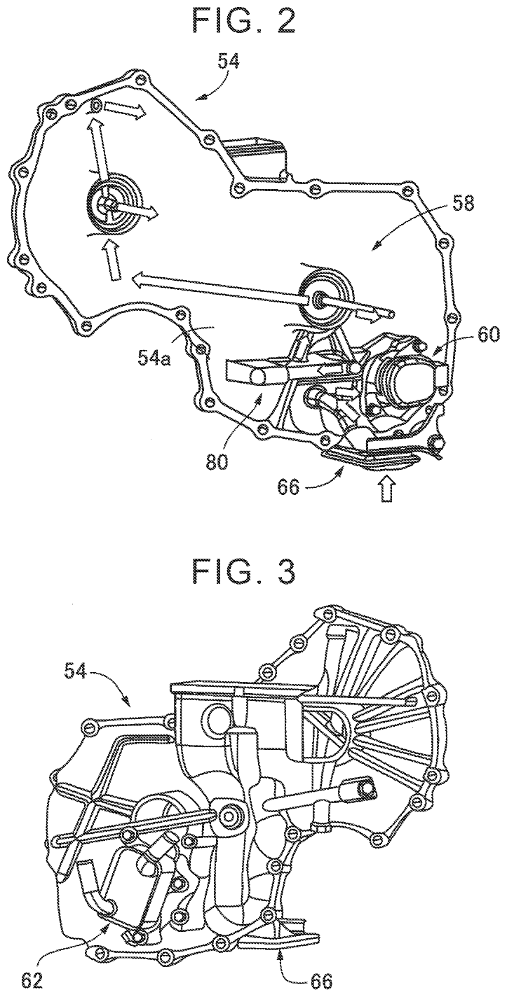

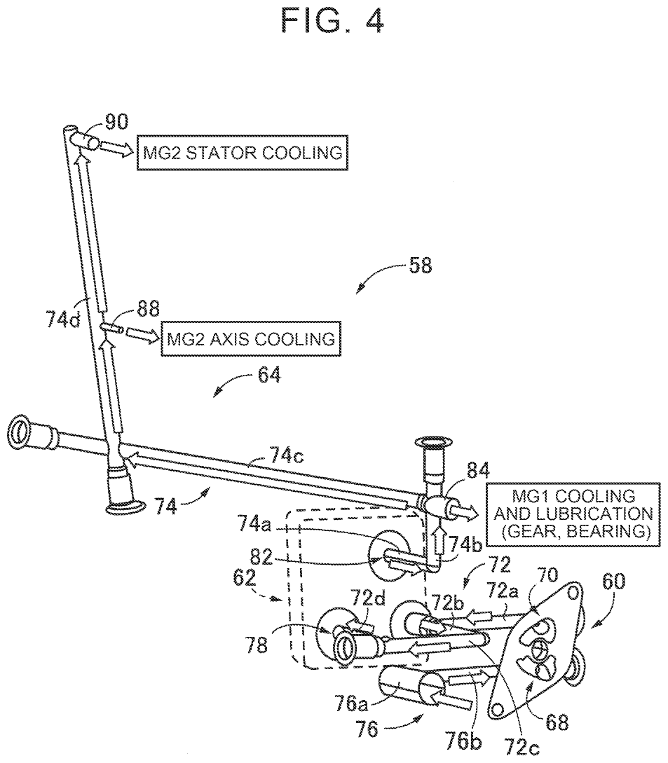

The power transmission device 10 includes a cooling mechanism 58 that cools each electric motor MG by supplying oil to each electric motor MG. Hereinafter, the structure of the cooling mechanism 58 will be described with reference to FIGS. 2 to 4. FIG. 2 corresponds to a view of the rear cover 54 from the inside side of the power transmission device 10. FIG. 3 corresponds to a view in which the rear cover 54 is viewed from the outside side of the power transmission device 10. FIG. 4 is a view showing the structure of the cooling oil passage 64 formed in the rear cover 54.

The cooling mechanism 58 includes an oil pump 60 that sucks up the oil stored in the lower portion of the case 12 in the vertical direction in the vehicle-mounted state, an oil cooler 62 that cools the oil discharged from the oil pump 60, a cooling oil passage 64 that guides the oil to the electric motor MG, and a strainer 66 that is a filter that filters the oil sucked up by the oil pump 60.

The oil pump 60 is an electric oil pump whose driving state is controlled by a command signal from an electronic control unit (not shown). When the oil pump 60 is driven, the oil stored in the lower portion of the case 12 is sucked into the oil pump 60 from the oil suction port 68 of the oil pump 60 via the strainer 66, and is discharged from the oil discharge port 70. The oil pump 60 is disposed on the inner side of the case 12 in a vehicle-mounted state, and is integrally provided with the rear cover 54 by bolt fastening or the like.

As illustrated in FIG. 3, the oil cooler 62 is disposed on the outer side of the case 12 in the vehicle mounted state, and is integrally provided with the rear cover 54 by bolt fastening or the like. The oil cooler 62 is, for example, an air-cooled type or a water-cooled type. Oil discharged from the oil discharge port 70 of the oil pump 60 is supplied to the oil cooler 62 via a first oil passage 72 which will be described later.

The oil cooler 62 includes an oil inflow port 78 through which oil flows and an oil outflow port 82 through which oil flows. When oil flows in from the oil inflow port 78 of the oil cooler 62, the oil is dissipated and cooled in a process of passing through a conduit (not shown) in the oil cooler 62. The oil that has passed through the pipeline of the oil cooler 62 flows out from the oil outflow port 82.

As illustrated in FIG. 4, the cooling oil passage 64 includes a first oil passage 72 that guides the oil discharged from the oil discharge port 70 of the oil pump 60 to the oil cooler 62, a second oil passage 74 that guides the oil cooled by the oil cooler 62 to the respective electric motors MG, and a third oil passage 76 that guides the oil that has passed through the strainer 66 to the oil suction port 68 of the oil pump 60.

The first oil passage 72 includes a first communication oil passage 72a connected to the oil discharge port 70, a second communication oil passage 72b communicating with the first communication oil passage 72a, a third communication oil passage 72c communicating with the second communication oil passage 72b, and a fourth communication oil passage 72d communicating with the third communication oil passage 72c and connected to the oil inflow port 78 of the oil cooler 62. As shown in FIG. 4, openings are formed at one longitudinal end of the fourth communication oil passage 72d from the first communication oil passage 72a. These openings correspond to drillholes formed in the wall surface of the rear cover 54 when forming the fourth communication oil passage 72d from the first communication oil passage 72a to the rear cover 54. These openings are closed during assembly to prevent oil from flowing out.

Each of the fourth communication oil passage 72d from the first communication oil passage 72a is formed in the rear cover 54. Further, the fourth communication oil passage 72d from the second communication oil passage 72b is formed in the protruding portion 80 (see FIG. 2) protruding perpendicularly to the wall surface 54a of the rear cover 54.

The second oil passage 74 includes a first communication oil passage 74a connected to the oil outflow port 82 of the oil cooler 62, a second communication oil passage 74b communicating with the first communication oil passage 74a, a third communication oil passage 74c communicating with the second communication oil passage 74b, and a fourth communication oil passage 74d communicating with the third communication oil passage 74c. As shown in FIG. 4, openings are formed at one longitudinal end of the fourth communication oil passage 74d from the first communication oil passage 74a. These openings correspond to drillholes formed in the wall surface of the rear cover 54 when forming the fourth communication oil passage 74d from the first communication oil passage 74a to the rear cover 54. These openings are closed during assembly to prevent oil from flowing out.

Each of the fourth communication oil passage 74d from the first communication oil passage 74a is formed in the rear cover 54. A MG1 cooler 84 is formed at a portion where the second communication oil passage 74b and the third communication oil passage 74c are connected. MG1 cooling-hole 84 is in communication with the second communication oil passage 74b. MG1 cooling-hole 84 is connected to an oil passage formed in the rotor shaft 24 of the first electric motor MG1. Accordingly, the oil flowing out of MG1 cooling-hole 84 is supplied to an oil passage formed in the rotor shaft 24.

A MG2 cooler 88 is formed in the middle portion of the fourth communication oil passage 74d in the longitudinal direction. MG2 cooling-hole 88 communicates with the fourth communication oil passage 74d. MG2 cooling-hole 88 is connected to an oil passage formed in the rotor shaft 38 of the second electric motor MG2. Accordingly, the oil flowing out of MG2 cooling-hole 88 is supplied to an oil passage formed in the rotor shaft 38.

A MG2 stator-cooling-hole 90 is formed at a longitudinal end of the fourth communication oil passage 74d. MG2 stator cooling-hole 90 is in communication with the fourth communication oil passage 74d. MG2 stator cooling-hole 90 is disposed vertically above the stator MG2s of the second electric motor MG2. MG2 stator cooling-hole 90 is connected to a pipe provided vertically above the second electric motor MG2 in a vehicle-mounted condition. Therefore, the oil flowing out of MG2 stator-cooling-hole 90 is supplied to the pipe.

The third oil passage 76 includes a first communication oil passage 76a connected to the strainer 66, and a second communication oil passage 76b communicating with the first communication oil passage 76a and connected to the oil suction port 68 of the oil pump 60. The first communication oil passage 76a is formed of a pipe-shaped member that connects the strainer 66 and the second communication oil passage 76b. The second communication oil passage 76b is formed in the rear cover 54.

The arrows shown in FIGS. 2 and 4 indicate the flow of oil in the cooling mechanism 58. When the oil pump 60 is driven, the oil stored in the lower portion of the case 12 is sucked into the oil pump 60 from the oil suction port 68 via the strainer 66 and the third oil passage 76, and is discharged from the oil discharge port 70. The oil discharged from the oil discharge port 70 sequentially flows into the oil cooler 62 through the first communication oil passage 72a, the second communication oil passage 72b, the third communication oil passage 72c, and the fourth communication oil passage 72d. The oil flowing into the oil cooler 62 is cooled in the oil cooler 62 and then flows out from the oil outflow port 82.

The oil flowing out of the oil outflow port 82 is supplied to the second oil passage 74. The oil supplied to the second oil passage 74 flows in the order of the first communication oil passage 74a, the second communication oil passage 74b, the third communication oil passage 74c, and the fourth communication oil passage 74d, as indicated by arrows. Here, a part of the oil flowing through the second communication oil passage 74b flows out of MG1 cooler 84 formed in the second communication oil passage 74b. The oil flowing out of MG1 cooling-hole 84 passes through an oil passage formed in the rotor shaft 24 of the first electric motor MG1, and is supplied to a rotor MG1r of the first electric motor MG1, a bearing 86a, 86b that rotatably supports the rotor shaft 24, and the like (see FIG. 1). Further, a part of the oil flowing through the oil passage in the rotor shaft 24 passes through the rotor shaft 24 and is also supplied to the planetary gear unit 20, a bearing that supports the planetary gear unit 20, and the like.

In addition, a part of the oil flowing through the fourth communication oil passage 74d of the second oil passage 74 flows out of MG2 cooler 88. The oil flowing out of MG2 cooling-hole 88 passes through an oil passage formed in the rotor shaft 38 of the second electric motor MG2, and is supplied to a rotor MG2r of the second electric motor MG2, a bearing 92a, 92b that rotatably supports the rotor shaft 38, and the like (see FIG. 1). Further, a portion of the oil flowing through the fourth communication oil passage 74d of the second oil passage 74 flows out of MG2 stator-cooling-hole 90. The oil flowing out of MG2 stator cooling-hole 90 is supplied to the stator MG2s of the second electric motor MG2 from the vertical upper side of the second electric motor MG2, for example, through a not-shown pipe.

In the cooling mechanism 58 of the present embodiment, the oil pump 60 and the oil cooler 62 are provided in the rear cover 54, and a first oil passage 72 for guiding the oil discharged from the oil pump 60 to the oil cooler 62 is formed in the rear cover 54. As a result, the length of the first oil passage 72 is shortened. A second oil passage 74 that guides the oil cooled by the oil cooler 62 to the respective electric motors MG is also formed in the rear cover 54. Therefore, since the cooling oil passage 64 constituting the cooling mechanism 58 is integrated into the rear cover 54, the cooling oil passage 64 is shortened as a whole, and the cooling oil passage 64 is simplified, so that the stagnation point of the oil in the cooling oil passage 64 is reduced. As a result, the pipe loss in the cooling oil passage 64 is reduced, and the cost for forming the cooling oil passage 64 is also reduced. Further, since the cooling oil passage 64 is formed in the rear cover 54, the oil flowing in the cooling oil passage 64 is dissipated by the air flowing in the side surface of the cooling oil passage 64.

An electric oil pump is used as the oil pump 60. Therefore, the discharge rate (flow rate) of the oil discharged from the oil pump 60 can be adjusted in accordance with the demand for cooling the electric motor MG and the demand for lubricating the various gears and the bearings. For example, when the electric motor MG generates heat, the power of the oil pump 60 is increased to appropriately cool the electric motor MG. On the other hand, when only various types of gears and bearings are required to be lubricated, the required quantity of oil is smaller than that at the time of heat generation of the electric motor MG, and thus the power of the oil pump 60 is lowered. Alternatively, for example, the oil pump 60 is driven every time the traveling distance reaches a predetermined distance. As described above, when the amount of heat generated by each electric motor MG is small and the motor temperature of each electric motor MG is low, for example, during light-load running in an urban area, the power of the oil pump 60 is lowered, so that the electric efficiency and the fuel efficiency can be improved. When the oil pump 60 is composed of a mechanical oil pump, the discharge amount (flow rate) of the oil pump 60 cannot be adjusted. In this case, since the oil is discharged from the oil pump 60 in accordance with the vehicle speed and the like regardless of the demand for cooling of the electric motor MG and the demand for lubrication of various gears and bearings, the drive loss of the pump, the drag of the oil, and the stirring loss occur.

As described above, according to the present embodiment, since the oil pump 60 and the oil cooler 62 are provided in the rear cover 54 and the cooling oil passages 64 of the respective electric motors MG are integrated in the rear cover 54, the cooling oil passages 64 do not pass through other parts other than the rear cover 54. Consequently, it is possible to shorten the cooling oil passages 64 through which oil is guided to the respective electric motors MG.

Further, according to the present embodiment, since the first oil passage 72 and the second oil passage 74 constituting the cooling oil passage 64 are formed in the rear cover 54, the length of the cooling oil passage 64 can be shortened as compared with the case where the first oil passage 72 and the second oil passage 74 pass through other case members. Further, since the oil pump 60 is an electric oil pump, the power can be adjusted according to the demand for cooling the electric motor MG and the demand for lubricating the various gears and bearings, and thus the power consumption and the fuel consumption can be improved.

Although the examples of the present disclosure have been described in detail with reference to the drawings, the present disclosure also applies to other modes.

For example, in the above-described embodiment, the vehicle power transmission device 10 is a hybrid-type power transmission device using the engine 14 and the second electric motor MG2 as power sources. However, the present disclosure is not necessarily limited to a hybrid type power transmission device. For example, the present disclosure can be applied to a battery electric vehicle using only an electric motor as a power source. The present disclosure can also be applied to a hybrid type power transmission device other than the power transmission device 10. For example, the present disclosure can be applied to a one-motor type power transmission device in which an electric motor is interposed between an engine and a transmission. In short, the present disclosure can be applied to at least a power transmission device using an electric motor as a power source.

In the above-described embodiment, the oil pump 60 is constituted by an electric oil pump. However, the present disclosure is not necessarily limited thereto. For example, the mechanical oil pump may be a mechanical oil pump driven by the engine 14 or a mechanical oil pump driven by a predetermined gear of the power transmission device 10, such as a mechanical oil pump driven by the differential ring gear 44 of the differential device 42.

In the above-described embodiment, the case 12 includes three case members, namely, the housing 50, the casing 52, and the rear cover 54. However, the present disclosure is not limited to three case members. The case may be composed of, for example, two or four or more case members. In short, as long as the case is composed of a plurality of case members including a rear cover, the case can be applied to the present disclosure.

It should be noted that the examples described above are merely embodiments, and the present disclosure can be implemented in a mode in which various changes and improvements are made based on the knowledge of those skilled in the art.

What is claimed is:

1. A cooling mechanism of a vehicle power transmission device that uses at least an electric motor as a power source, wherein:
a case for accommodating the electric motor includes at least a rear cover that is adjacent to the electric motor in a direction of a rotation axis of the electric motor and that is disposed perpendicularly to the rotation axis of the electric motor;
an oil pump and an oil cooler are provided on the rear cover; and
a cooling oil passage for guiding oil to the electric motor is integrated in the rear cover.

2. The cooling mechanism of the vehicle power transmission device according to claim 1, wherein:
the case is composed of a plurality of case members including the rear cover;
the cooling oil passage includes
a first oil passage for guiding oil discharged from the oil pump to the oil cooler, and
a second oil passage for guiding oil cooled by the oil cooler to the electric motor; and
the first oil passage and the second oil passage are provided in the rear cover.

3. The cooling mechanism of the vehicle power transmission device according to claim 1, wherein the oil pump is an electric oil pump.
